(19) United States
(12) Patent Application Publication
(10) Pub. No.: US 2015/0178687 A1
(43) Pub. Date: Jun. 25, 2015

(54) SYSTEM AND METHOD FOR IMPROVING RESOURCE UTILIZATION

(71) Applicant: Murty V. V. S. R. S. N. Dasari, Cupertino, CA (US)

(72) Inventor: Murty V. V. S. R. S. N. Dasari, Cupertino, CA (US)

(73) Assignee: Google Inc., Mountain View, CA (US)

(21) Appl. No.: 13/457,388

(22) Filed: Apr. 26, 2012

(51) Int. Cl. G06Q 10/10; H04W 64/00

(52) U.S. Cl. CPC G06Q 10/1095; H04W 64/00

(57) ABSTRACT

A system and a computer-implemented method for notifying a party of an appointment status is provided. Information corresponding to an appointment between two or more parties is received, and a location of a first party of the two or more parties is retrieving. Additional data points relating to the first party is further retrieved from at least one datasource. An expected time of commencement of the appointment is determined based on the received information corresponding to the appointment, the retrieved location, and the retrieved additional data points. A notification to at least a second party of the two or more parties is provided based on the determined expected commencement time of the appointment.

### FIELD

The present disclosure generally relates to improving resource utilization, and, in particular, to providing notifications of a status of an appointment between multiple parties.

### BACKGROUND

Consumers often schedule appointments with service providers for a variety of different services. For example, a consumer may make a reservation for a table in a restaurant, or a patient may schedule an appointment with a doctor. While appointments allow consumers and service providers to properly plan their respective schedules, certain circumstances may cause a change in timing for the consumer or the service provider, or both. Thus, it may be desirable to provide a system that automatically provides notifications of a status of an appointment between multiple parties.

### SUMMARY

The disclosed subject matter relates to a computer-implemented method for notifying a party of an appointment status. Information corresponding to an appointment between two or more parties is received, and a location of a first party of the two or more parties is retrieved. Additional data points relating to the first party is further retrieved from at least one datasource. An expected time of commencement of the appointment is determined based on the received information corresponding to the appointment, the retrieved location, and the retrieved additional data points. A notification to at least a second party of the two or more parties is provided based on the determined expected commencement time of the appointment.

According to various aspects of the subject technology, a system for notifying a party of an appointment status is provided. The system includes one or more processors and a machine-readable medium comprising instructions stored therein, which when executed by the processors, cause the processors to perform operations comprising receiving information corresponding to an appointment between a first party and a second party. A location of the first party is retrieved. Data points relating to the first party and data points relating to the second party are retrieved from at least one datasource. An expected time of arrival of the first party at the appointment is determined based on the retrieved location of the first party and the retrieved data points relating to the first party. An expected time of availability of resources required for the appointment is determined based on the retrieved data points relating to the second party. A notification is provided to the first party when the expected time of availability of resources required for the appointment is later than the expected time of arrival of the first party at the appointment. Additionally, a notification is provided to the second party when the expected time of arrival of the first party at the appointment is later than the expected time of availability of resources required for the appointment.

The disclosed subject matter also relates to a machine-readable medium comprising instructions stored therein, which when executed by a system, cause the system to perform operations comprising receiving information corresponding to an appointment between a first party and at least a second party. Data points relating to the first party are retrieved from at least one datasource. The data points include information on an availability of resources and a quantity of available resources. An expected time of commencement of the appointment is determined based on the received information corresponding to the appointment and the retrieved data points. A notification is provided to the at least second party based on the determined expected commencement time of the appointment.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for providing notifications of a status of an appointment between multiple parties.

FIG. 2 illustrates an example of a server system for providing notifications of a status of an appointment between multiple parties.

FIG. 3 illustrates an example method for providing notifications to a party of an appointment that indicates the status of the appointment based on an estimation of an arrival time of a mobile party of an appointment.

FIG. 4 illustrates an example method for providing notifications to a party of an appointment that indicates the status of the appointment based on an estimation of a time when resources become available for of an appointment.

FIG. 5 illustrates an example of a system for providing notifications of a status of an appointment between multiple parties.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter relates to a computer-implemented method for notifying a party of an appointment status. Information corresponding to an appointment between two or more parties is received, and a location of a first party of the two or more parties is retrieved. Additional data points relating to the first party is further retrieved from at least one datasource. An expected time of commencement of the appointment is determined based on the received information corresponding to the appointment, the retrieved location, and the retrieved additional data points. A notification to at least a second party of the two or more parties is provided based on the determined expected commencement time of the appointment.

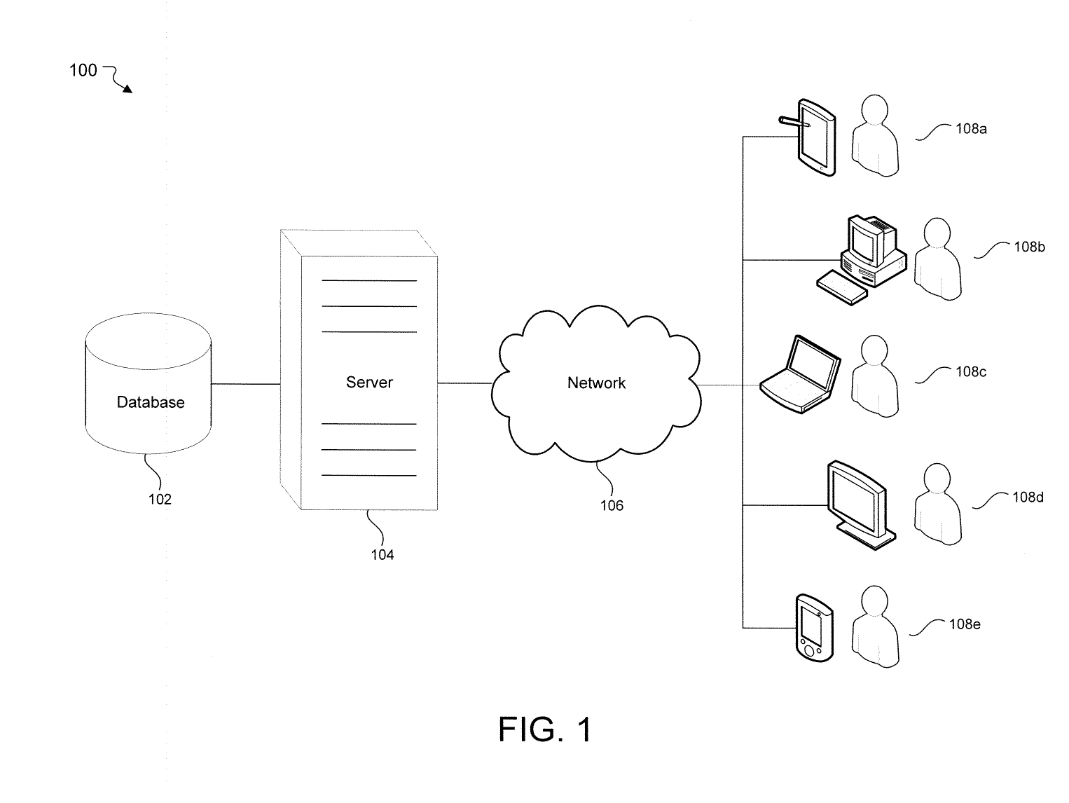

FIG. 1 illustrates an example network environment 100 comprising one or more databases 102 (e.g., computer-readable storage devices) for storing a variety of data accessed by web-based and mobile applications. The network environment 100 further comprises one or more servers 104. Server 104 may receive requests from user-operated client devices 108a-108e. Server 104 and client devices 108a-108e may be communicatively coupled through a network 106. In some implementations, client devices 108a-108e may request data from server 104. Upon receiving the request, server 104 may retrieve a set of data from database 102 and serve the set of information to client devices 108a-108e.

Each of client devices 108a-108e can represent various forms of processing devices. Example processing devices can include a desktop computer, a laptop computer, a handheld computer, a tablet, a television with one or more processors attached or coupled thereto, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices.

In some aspects, client devices 108a-108e may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108a-108e) can communicate with servers 104 via a virtual private network (VPN), Secure Shell (SSH) tunnel, or other secure network connection. In some aspects, network 106 may further include a corporate network (e.g., intranet) and one or more wireless access points.

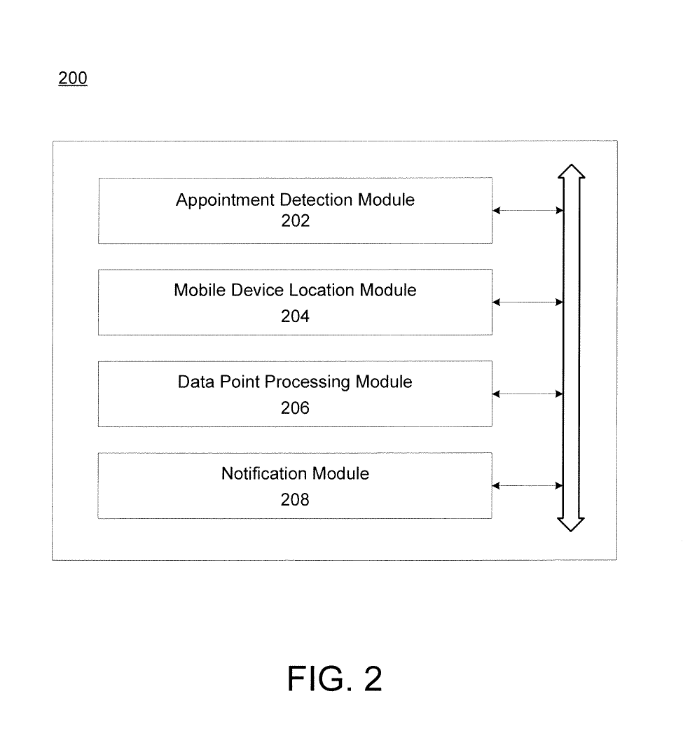

FIG. 2 illustrates an example of a server system for providing notifications of a status of an appointment between multiple parties. System 200 includes appointment detection module 202, mobile device location module 204, data point processing module 206, and notification module 208. These modules, which are in communication with one another, process information received from client devices 108a-108e and retrieved from database 102 in order to determine when to provide notification to a party of an appointment status. Appointment information may be detected by appointment detection module 202. A time and a location of a scheduled appointment may be determined based on the detected appointment information by appointment detection module 202.

The location of each of the client devices 108a-108e may be determined by mobile device location module 204. For example, a location of a mobile party of the appointment operating the mobile device may be determined by mobile device location module 204. The location may be determined from Global Positioning System (GPS) coordinates sent from the mobile device. Additional data points may be retrieved and processed by data point processing module 206. When the location of the mobile party of the appointment is determined and the data points are obtained, data point processing module 206 may calculate an amount of time required for the mobile party to arrive at the location of the scheduled appointment. If the amount of time required exceeds the difference between a time of the appointment and the current time, notification module 208 may provide a notification to the corresponding party of the scheduled appointment.

Data point processing module 206 may also retrieve and process information related to the providing party of the appointment. For example, such information may include a time and an amount of resources available. Based on this information, data point processing module 206 may estimate a time at which resources required for the appointment become available. If the estimated time is latter than the time of the appointment, notification module 208 may provide a notification to the mobile party to indicate the status of the appointment.

In some aspects, the modules may be implemented in software (e.g., subroutines and code). The software implementation of the modules may operate on web browsers running on client devices 108a-108e. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

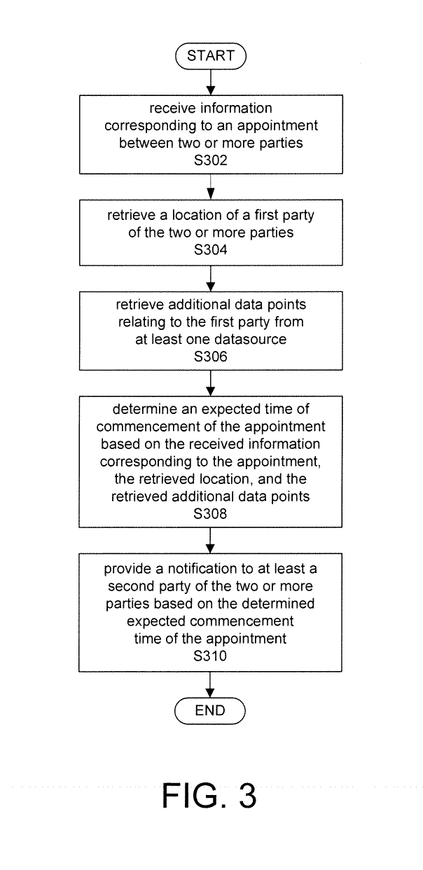

FIG. 3 illustrates an example method for providing notifications to a party of an appointment that indicates the status of the appointment based on an estimation of an arrival time of a consumer party of an appointment. Information corresponding to an appointment between two or more parties may be received, according to S302. The two or more parties may include at least the consumer party and a provider party. The information corresponding to the appointment between the two or more parties may be time and location information regarding the appointment. Time information may include a specific date and a time of the appointment, and location information may include a street address or GPS coordinates of the location of the appointment. For example, an individual may have made a reservation at a restaurant located at 10 Columbus Circle in New York City for Monday at 8:00PM. Accordingly, when information corresponding to this appointment is retrieved, the information may include a location of 10 Columbus Circle, New York, N.Y. 10019, and a time of Monday at 8:00PM.

A location of a consumer party of the appointment may be retrieved, according to S304. The location information of the consumer party may be retrieved as GPS coordinates provided by a mobile device operated by the consumer party. The location (e.g., street address) of the consumer party may be determined using these GPS coordinates. In some implementations, the location information for the consumer party may correspond to a location of a wireless network (i.e., a wireless internet network or a cellular network) to which the mobile device of the consumer party is connected to and in communication with. The location of the appointment and the location of the consumer party provide two distinct locations from which a proposed route to the appointment taken by the consumer party may be established. Once the proposed route has been established, a duration of transit of the consumer party may further be determined, as described in further details below.

In some implementations, a selection may be made on the mobile device to turn off a tracking mode so that location information can not be retrieved from the mobile device operated by the consumer party. In some aspects, the tracking mode may be set to off by default. In this example, the tracking mode is set to on only when consent to tracking is provided by the consumer party via the mobile device.

Additional data points relating to the consumer party may further be retrieved from at least one datasource, according to S306. The data points relating to the consumer party may include data points that affect the transit of the consumer party from a current location to the location of the appointment. The data points retrieved from at least one datasource may include traffic information, reported accidents, mass transit schedules, mass transit delays, and any other obtainable web-based transit related information. Additional data points may include transit schedules which provide information such as locations of mass transit stops, departure times, and arrival times of certain mass transit vehicles. Transit vehicles may include planes, trains, subways, ferries, and buses. The determined duration of transit may be adjusted by any individual or combination of the retrieved data points.

An expected time of commencement of the appointment may be determined based the information corresponding to the appointment, the location of the consumer party, and the additional data points relating to the consumer party, according to S308. The expected time of commencement of the appointment corresponds to an estimate of a time required for the consumer party to travel from its current location to the location of the appointment. That is, if the consumer party is 5 miles away and an average transit rate of 10 miles per hour is applied, then the expected time of commencement of the appointment will be determined to be 30 minutes from the current time.

The retrieved additional data points may further be used to make adjustments to the expected time of commencement of the appointment. For example, traffic information and/or reported accidents along the proposed route may cause a duration of transit to be extended and the expected time of commencement of the appointment to be delayed. In some implementations, if the consumer party is determined to be using mass transit, the estimation may be adjusted based on a mass transit schedule. Arrival times of a mass transit vehicle at a mass transit stop within close proximity to the location of the appointment may be used to adjust the expected time of commencement. The time required to walk to and from locations of mass transit stops, as well as any intervening transfers required to get to the location of the appointment, may further be used in the adjustment.

Once the expected time of commencement of the appointment has been determined, a notification may be provided to at least the provider party of the appointment based on the determined expected commencement time of the appointment. The notification provided to at least the provider party include updates of the expected arrival of the consumer party. Further to the above example, if a duration of transit is 45 minutes and the scheduled appointment is to occur 30 minutes from the current time, the notification will be provided to the provider party to indicate that the consumer party will late.

In some implementation, a quantitative value specifying how late the consumer party will be may be provide to the provider party. That is, if the consumer party is expected to be 15 minutes late for the appointment, the notification provided to the provider party may indicate that the consumer party will be 15 minutes late. Alternatively, if the consumer party is expected to be early for the appointment, the notification provided to at least the provider party may provide a quantitative value indicating how early the consumer party may be.

In some implementations, the expected time of commencement is determined based on the distance of the proposed route to the appointment taken by the consumer party divided by an average rate of travel associated with a style of transit used by the consumer party. For example, if the consumer party travels by car to the appointment, the average rate of travel may be associated with the types of roads that connect the location of the consumer party and the location of the appointment. If the consumer party travels via mass transit, the average rate of travel may be associated with the departure and arrival times of a mass transit schedule. Once a mode of transit is identified, dividing the distance of the proposed route divided by the average rate of travel of the identified mode of transit may produce an expected time of commencement.

The mode of transit may be identified in a variety of ways. In some implementations, information on the mode of transit may be provided by the consumer party through the mobile device operated by the consumer party. That is, the consumer party may indicate on the mobile device the mode of transit being used (e.g., walking, by car, by subway, by bus, etc). The mode of transit may also be predicted through updates of location information received from the mobile device of the consumer party. For example, if a route that the consumer party is proceeding on and the rate of travel corresponds to a car driving on the highway, the mode of transit may be predicted to be by car and an average rate of travel of a car may be used. Similarly, if the travel along a route and a speed of travel along that route correspond to a bus, the mode of transit may be predicted to be by bus. In this case, a schedule of the bus route including arrival times may be used to determine an average rate of travel. Other modes of transit (e.g., by bicycle, by rail, by plane, by ferry, etc.) may also be identified based on geographic progress and the rate of travel.

In some implementations, messages may be received from the mobile device of the consumer party. The messages may include an expected time of commencement provided by the consumer party. For example, if the consumer party has a scheduling conflict and expects to be late for the appointment, the consumer party may send a message indicating such lateness. The message may include a value of how late the consumer party estimates that he will be. Once the message is received from the consumer party, a notification may be disseminated to the other parties of the appointment of this status update provided by the consumer party. In some implementations, this message may be received from the mobile device of the consumer party as an SMS.

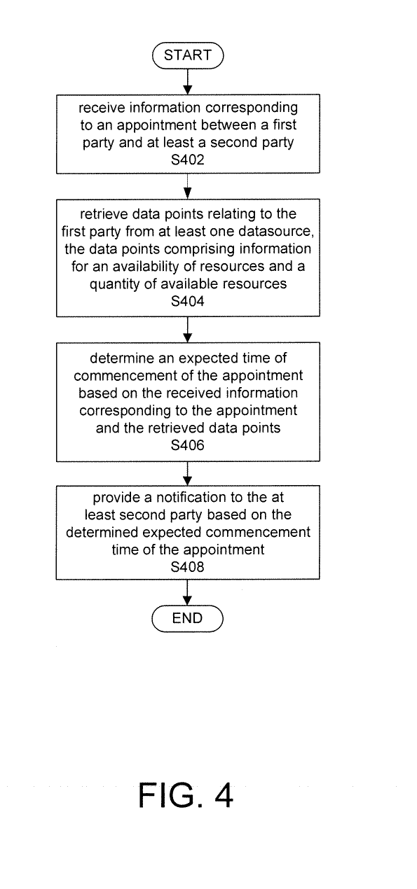

FIG. 4 illustrates an example method for providing notifications to a party of an appointment that indicates the status of the appointment based on an estimation of a time when resources become available for of an appointment. Information corresponding to an appointment between two or more parties may be received, according to S402. The two or more parties may include at least a consumer party and a provider party. The information corresponding to the appointment between the two or more parties may be time and location information regarding the appointment. Time information may include a specific date and a time of the appointment, and location information may include a street address or GPS coordinates of the location of the appointment. As provided in the example above, an individual may have made a reservation at a restaurant located at 10 Columbus Circle in New York City for Monday at 8:00PM. Accordingly, when information corresponding to this appointment is retrieved, the information may include a location of 10 Columbus Circle, New York, N.Y. 10019, and a time of Monday at 8:00PM. The information corresponding to the appointment between the two or more parties may also include information about the amount of resources required to fulfill the appointment. For example, the reservation for Monday at 8:00PM may be a reservation for a party of four guests.

Additional data points relating to the provider party may be retrieved from at least one datasource, according to S404. The data points relating to the provider party may include data points that provide an indication of an availability of resources for the appointment at the scheduled time. The data points retrieved from at least one datasource may include an availability of resources and the quantity of resources available. An expected time of commencement of the appointment may be determined based the information corresponding to the appointment and the additional data points relating to the provider party, according to S406. The expected time of commencement of the appointment corresponds to an estimate of a time required for the consumer party to travel from its current location to the location of the appointment. That is, if the provider party, based on the retrieved additional data points, will not have the resources required for the appointment available until 30 minutes from the current time, then the expected time of commencement of the appointment will be determined to be 30 minutes from the current time. Further to the restaurant reservation example, if the current time is 7:45PM and the provider party expected that a table for four would be available for an 8:00PM reservation, but none of the guests occupying tables for four or more guests are expected to leave earlier than 30 minutes from the current time, the expected time of commencement of the appointment will be determined to be 8:15PM. In other words, the retrieved additional data points may be used to make adjustments to the expected time of commencement of the appointment.

Once the expected time of commencement of the appointment has been determined, a notification may be provided to the consumer party of the appointment based on the determined expected commencement time of the appointment. The notification provides real-time updates of the expected time that resources to accommodate the appointment become available. In some implementation, a quantitative value specifying how late the resource availability will be may be provide to the consumer party. That is, if the resources are expected to be available 15 minutes after the appointment time, the notification provided to the consumer party may indicate that the provider party is running 15 minutes late. Alternatively, if resources are expected to be freed up earlier than the appointment time, the notification provided to the consumer party may provide a quantitative value indicating how much early the resources may be made available.

In some implementations, an expected time of arrival of the consumer party is determined based on the location of the consumer party and the location of the appointment. The distance of the proposed route to the appointment taken by the consumer party may divided by an average rate of travel associated with a style of transit used by the consumer party, as discussed above by reference to FIG. 3. The expected time of arrival of the consumer party is compared to the expected commencement time of the appointment. When the expected commencement time of the appoint is later than the expected time of arrival of the consumer party, a notification may be provided to the consumer party indicating the status of the provider party. Conversely, when the expected commencement time of the appoint is earlier than the expected time of arrival of the consumer party, a notification may be provided to the provider party indicating the status of the consumer party.

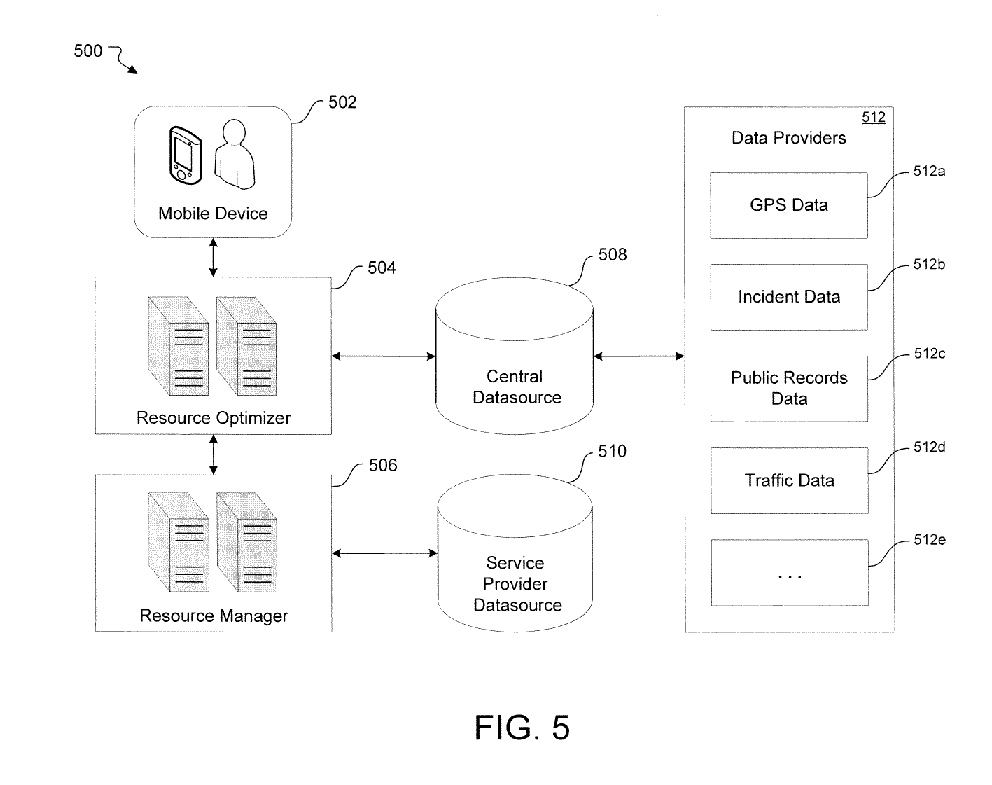

FIG. 5 illustrates an example of a system for providing notifications of a status of an appointment between multiple parties. System 500 includes mobile device 502, resource optimizer 504, resource manager 506, central datasource 508, service provider datasource 510, and data providers 512a-512e. Resource optimizer 504 is communicatively coupled to mobile device 502 of the consumer party in order to retrieve location information as well as to receive any messages sent by mobile device 502. Resource optimizer 504 is further communicatively coupled to resource manager 506 of the provider party. Information such as the time and location of the appointment as well as a real-time update of available resources are received from resource manager 506 by resource optimizer 504.

Resource optimizer 504 processes the information received/retrieved from mobile device 502 and resource manager 506 in order to provide notifications to the appropriate party with regards to the status of an appointment. Additionally, resource optimizer 504 may retrieve different data points form datasource 508. The additional data points stored on datasource 508 may originate from a variety of data providers 512. These data providers may provide information such as GPS data (for indicating different locations on maps), incident data (for providing up to date information on accidents and other events that affect the flow of traffic), public records data (for providing information on planned construction or street closures), traffic data (for providing information on general congestion as a result of the volume of vehicles on roads), etc. By retrieving the additional data points, resource optimizer 504 may predict a time when the consumer party may arrive for an appointment, and thus provide a more accurate update on the status of the appointment to the participating parties.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

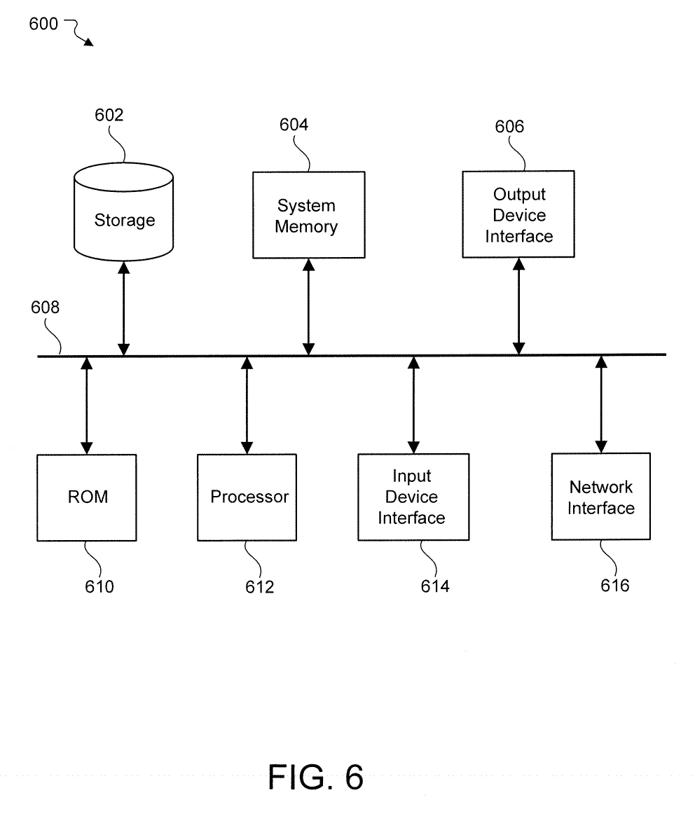

FIG. 6 conceptually illustrates an example electronic system with which some implementations of the subject technology are implemented. Electronic system 600 can be a computer, phone, PDA, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for providing notifications of a status of an appointment between multiple parties in accordance with some implementations. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interface 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers, such as a local area network (“LAN”), a wide area network (“WAN”), or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for notifying a party of an appointment status, the method comprising:
receiving, by one or more computing devices, information corresponding to an appointment, between a consumer party;
retrieving, by the one or more computing devices, a location of the consumer party;
retrieving, by the one or more computing devices, additional data points relating to the provider party from at least one datasource;
determining, by the one or more computing devices, an expected time of commencement of the appointment based on the retrieved additional, data points relating to the provider party; wherein the expected time of commencement is earlier than a time associated with the appointment;
determining an expected arrival time of the consumer party based on the location of the consumer party and a location associated with the appointment;
providing a notification to the provider party when the expected commencement time is earlier than the expected arrival time of the consumer party;
providing, by the one or more computing devices, a notification to the consuming party providing a quantitative value indicating how much earlier the expected time of commencement is relative to the appointment.

2. (cancelled)

3. The computer-implemented method of claim 2, further comprising determining a route between the retrieved location of the first party and the location of the appointment, wherein the determining the expected arrival time comprises calculating a time required to cover a distance of the route based on an estimated rate of travel of the first party.

4. The computer-implemented method of claim 3, further comprising identifying at least one of a plurality of modes of transit, wherein the estimated rate of travel is determined based on the identified at least one of the plurality of modes of transit.

5. The computer-implemented method of claim 4, wherein the plurality of modes of transit comprise transit by foot, bicycle, car, subway, rail, or plane, each of the plurality of modes of transit corresponding to a different rate of travel utilized to determine the estimated rate of travel.

6. (canceled)

7. The computer-implemented method of claim 1, wherein retrieving the location of the at least one of the consuming party comprises retrieving the location from a location enabled application running on the mobile device operated by the consuming party.

8. The computer-implemented method of claim 1, wherein the location retrieved from the mobile device comprises Global Positioning System coordinates.

9. (canceled)

10. A non-transitory, machine-readable medium comprising instructions stored therein, which when executed by a system, cause the system to perform operations comprising:
receiving information corresponding to an appointment between a first party and at least a second party:
retrieving data points relating to the first party from at least one datasource, the data points comprising information on an availability of resources and a quantity of available resources;
determining an expected time of commencement of the appointment based on the received information corresponding to the appointment and the retrieved data points; wherein the expected time of commencement is earlier than a time associated with the appointment;
determining an expected arrival time of the second party based on a location of the second party and a location associated with the appointment;
providing a notification to the first party when the expected commencement time is earlier than the expected arrival time of the consumer party; and
providing a notification to the at least second party providing a quantitative value indicating how much earlier the expected time of commencement is relative to the appointment.

11. (canceled)

12. (canceled)

13. (canceled)

14. The machine-readable medium of claim 12, further comprising instructions for identifying at least one of a plurality of modes of transit, wherein the expected time of arrival is determined based on the identified at least one of the plurality of modes of transit, and wherein the plurality of modes of transit comprise transit by foot, bicycle, car, subway, rail, or plane, each of the plurality of modes of transit corresponding to a different rate of travel utilized to determine the estimated rate of travel.

15. The machine-readable medium of claim 10, wherein the information corresponding to the appointment between the first party and the at least second party comprises an amount of resources required to fulfill the appointment.

16. The machine-readable medium of claim 15, wherein the expected time of commencement is determined as a time when the quantity of available resources is greater than or equal to the amount of resources required to fulfill the appointment.

17. (canceled)

18. A system for notifying a party of an appointment status, the system comprising:
one or more processors; and
a machine-readable medium comprising instructions stored therein, which when executed by the processors, cause the processors to perform operations comprising:
receiving information corresponding to an appointment between a first party and a second party;
retrieving a location of the first party;
retrieving data, points relating to the first party and data points relating to the second party from at least one datasource;
determining an expected time of arrival of the first party at the appointment based on the retrieved location of the first party and the retrieved data points relating to the first party:
determining an expected time of availability of resources required for the appointment based on the retrieved data points relating to the second party; the expected time of availability of resources being earlier than a time associated with the appointment.
providing a notification to the second party when the expected time of arrival of the first party at the appointment is later than the expected time of availability of resources required for the appointment;
providing a notification to the first party providing a quantitative value indicating how much earlier the expected time of availability is relative to the appointment.

19. The system of claim 18, wherein the data points relating to the first party comprises at least one of traffic information, reported accidents along the determined route, or mass transit schedules, and wherein the data points relating to the second party comprises information on an availability of resources and a quantity of available resources.

20. The system of claim 19, wherein the determining the expected time of arrival of the first party at the appointment comprises estimating a time of arrival of the first party based on the received information corresponding to the appointment and the retrieved location of the first party, and adjusting the estimated time of arrival based on the at least one of traffic information, reported accidents along the determined route, or mass transit schedules, and wherein the determining the expected time of availability of resources required for the appointment is based on the availability of resources and the quantity of available resources.
